(19) United States
(12) Patent Application Publication
(10) Pub. No.: US 2018/0027745 A1
(43) Pub. Date: Feb. 1, 2018

(54) PLANT EDGING

(71) Applicant: Kent Stover, (US)

(72) Inventor: Kent Stover, Inver Grove Heights, MN (US)

(21) Appl. No.: 15/335,755

(22) Filed: Oct. 27, 2016

Related U.S. Application Data
(60) Provisional application No. 62/367,375, filed on Jul. 27, 2016.

(51) Int. Cl. A01G 1/08

(52) U.S. Cl. CPC A01G 1/08

(57) ABSTRACT

A plant edging is discloses herein that has an inner side and an outer side and includes a sidewall having a top end and a bottom end with the bottom end configured to engage soil, a head connected to the top end of the sidewall, and a rib connected to and extending away from the outer side near the bottom end of the sidewall to form a substantially V-shape with the bottom end of the sidewall with the rib having a distal end configured to engage soil.

### CROSS-REFERENCE TO RELATED APPLICATION

This application claims the benefit of U.S. Provisional Application No. 62/367,375 filed Jul. 27, 2016 for “Plant Edging” by Kent Stover.

### BACKGROUND

The present disclosure relates to landscaping and maintenance of plants and, in particular, to an edging surrounding an area for plants.

In landscaping and gardening, it has been conventional practice to surround plants, such as trees, flowers, and bushes, to provide protection and an aesthetic delineation between grass or other landscaping materials, such as stone, wood chips, sand, etc. The protection, which can come in the form of a plastic or brick edging, can retain water to conserve water and prevent runoff. Further, the edging may be helpful in controlling weed growth around the plant. The edging can provide delineation between grass, which will need to be cut by a lawn mower, and the plant that needs to be protected from damage due to a lawn mower.

Currently implemented edgings are two-dimensional barriers that extend straight into the ground and are installed in the ground with soil on an inner, plant side and landscaping materials on an outer side. The barriers can be pushed into the ground without the removal or addition of any materials around the barriers, or the barriers can be set on top of a surface with soil and other materials backfilled around the barriers. With the barriers being two dimensional, the barriers can move upwards (out of the ground) over time or be easily pulled upwards, causing time and expense in reinstalling the barrier. Often times, when landscaping materials like stone, wood chips, or sand are used to surround the outer side of the barriers, a fabric is first placed on the ground with the landscaping material placed on top of the fabric. With the two-dimensional barrier and the fabric intersecting at or close to a right angle, creating a tight seal that prevents the landscaping material from slipping through the interface between the barrier and the fabric is difficult because the fabric tends to fold back over on itself. Thus, there is need for an edging that cannot be easily pulled upwards out of the ground and that is able to provide a seal between the edging and the fabric.

### SUMMARY

A plant edging is discloses herein that has an inner side and an outer side and includes a sidewall having a top end and a bottom end with the bottom end configured to engage soil, a head connected to the top end of the sidewall, and a rib connected to and extending away from the outer side near the bottom end of the sidewall to form a substantially V-shape with the bottom end of the sidewall. The rib has a distal end configured to engage soil.

A planter ring is discloses herein that includes a wall that is annular in shape and has a radially inner side, a radially outer side, a top end, and a bottom end. The planter ring also includes a branch that is annular in shape and connected to the radially outer side of the wall near the bottom end with the branch extending to a point on a plane formed by a bottom of the planter ring.

The present summary is provided only by way of example and not limitation. Other aspects of the present disclosure will be appreciated in view of the entirety of the present disclosure, including the entire text, claims, and accompanying figures.

### BRIEF DESCRIPTION OF THE DRAWINGS

FIG. 1A is a perspective view of a plant edging.

FIG. 1B is a top plan view of the plant edging in FIG. 1A.

FIG. 1C is an elevation view of the plant edging in FIG. 1A.

FIG. 1D is a bottom plan view of the plant edging in FIG. 1A.

FIG. 1E is a cross-sectional elevation view of the plant edging in FIG. 1A.

FIG. 2 a cross-sectional elevation view of the plant edging in FIG. 1A installed in a landscaping environment.

FIG. 3 is a cross-sectional elevation view of one embodiment of a plant edging.

FIG. 4 is a cross-sectional elevation view of another embodiment of a plant edging.

FIG. 5A is a perspective view of another embodiment of a plant edging.

FIG. 5B is a cross-sectional elevation view of the plant edging of FIG. 5A.

While the above-identified figures set forth embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

A plant edging, which can also be configured in a continuous ring to form a planter ring, is disclosed herein having a sidewall, a head at a top end of the sidewall, and a rib connected to and extending away from an outer side of the sidewall. The plant edging provides protection to plants on an inner side of the plant edging and delineation from grass or other materials on an outer side of the plant edging. The rib, also called a branch, can form a substantially V-shape with a bottom end of the sidewall. The rib is configured to engage soil or a landscaping material, such as stone, gravel, wood chips, or sand, to prevent the plant edging from shifting or being pulled out of the ground in which the plant edging is installed. The rib is also configured to engage a fabric liner that is commonly utilized in landscaping, with the rib providing an angled surface to create a seal between the plant edging and fabric that prevents soil or the landscaping material from seeping through an interface between the two. The rib can extend at any angle and can be any length, including an angle that is as much as or more than sixty degrees from the sidewall and a length in which a distal end of the rib extends further downward than the bottom of the sidewall. Further, the rib and the bottom of the sidewall (the V-shape) can form a lift lip that connects the distal end of the rib and the bottom end of the sidewall to form a triangular member at the bottom of the pant edging for more support and strength. Teeth can be located on the bottom of the sidewall and on the distal end of the rib to aid in engagement of the plant edging with the soil or landscaping material. After reviewing the description and corresponding figures below, these and other benefits will be realized.

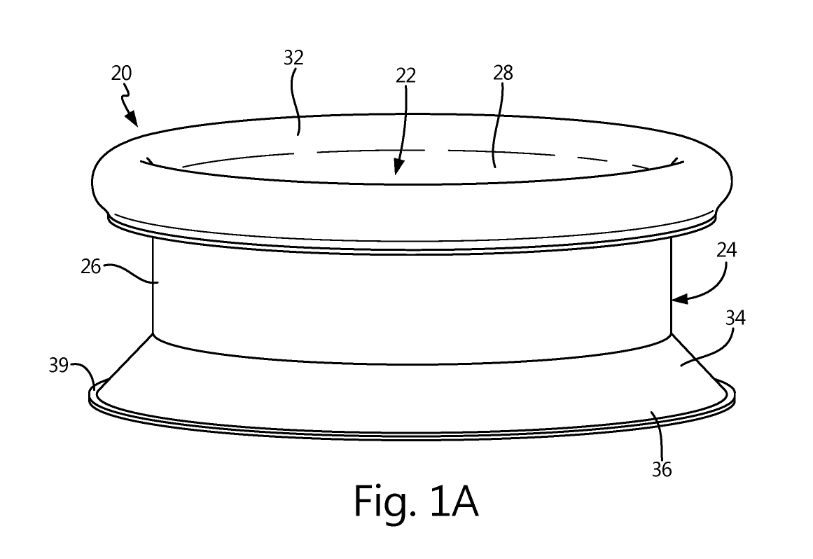

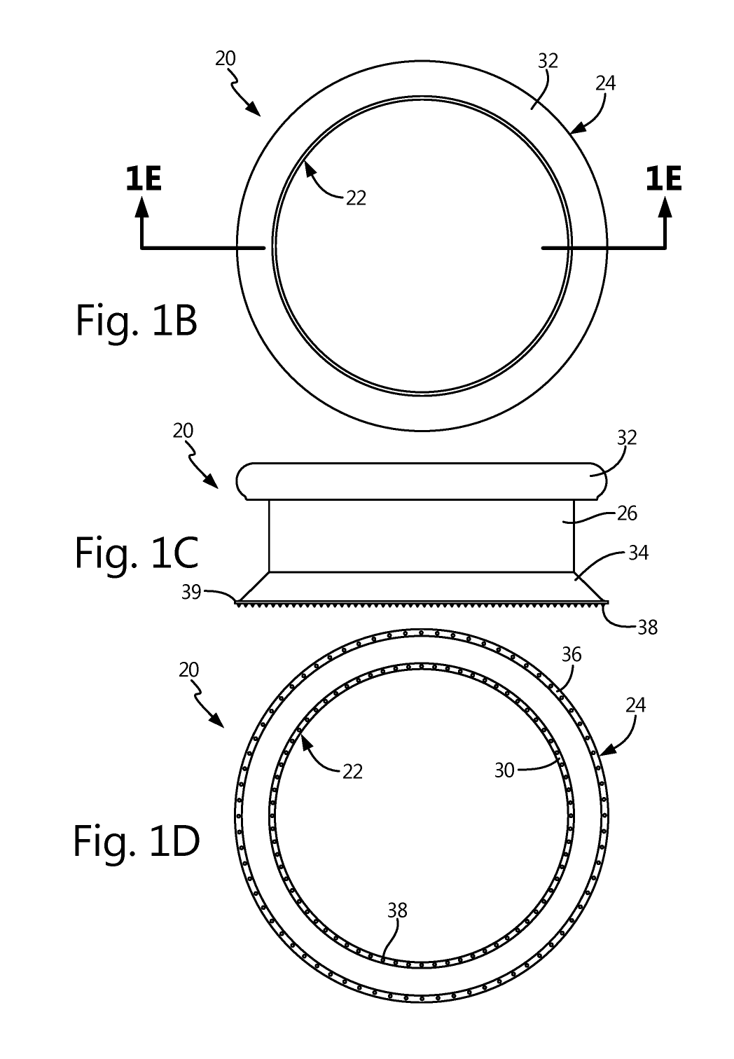

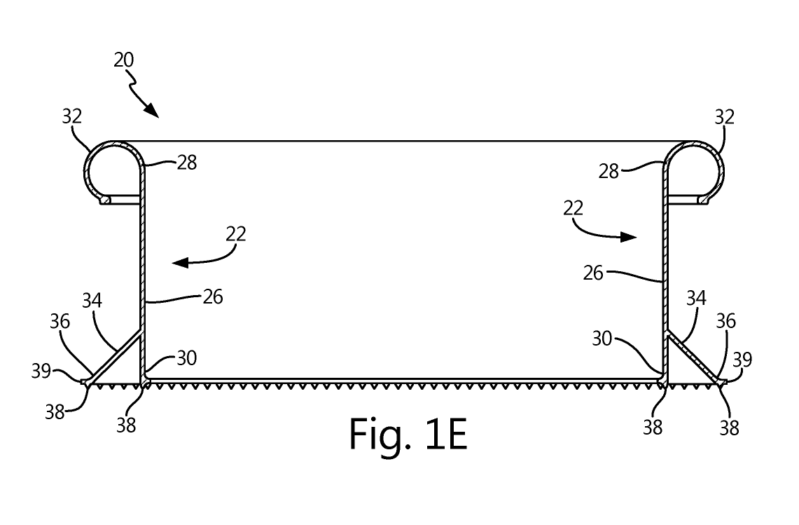

FIG. 1A is a perspective view of a plant edging, FIG. 1B is a top plan view of the plant edging in FIG. 1A, FIG. 1C is an elevation view of the plant edging in FIG. 1A, FIG. 1D is a bottom plan view of the plant edging in FIG. 1A, and FIG. 1E is a cross-sectional elevation view of the plant edging in FIG. 1A. Plant edging 20 (which, when in an annular shape, can be referred to as a planter ring) includes radially inner side 22, radially outer side 24, sidewall 26 with top end 28 and bottom end 30, head 32, rib 34, and teeth 38. Rib 34 includes distal end 36 and rib flange 39.

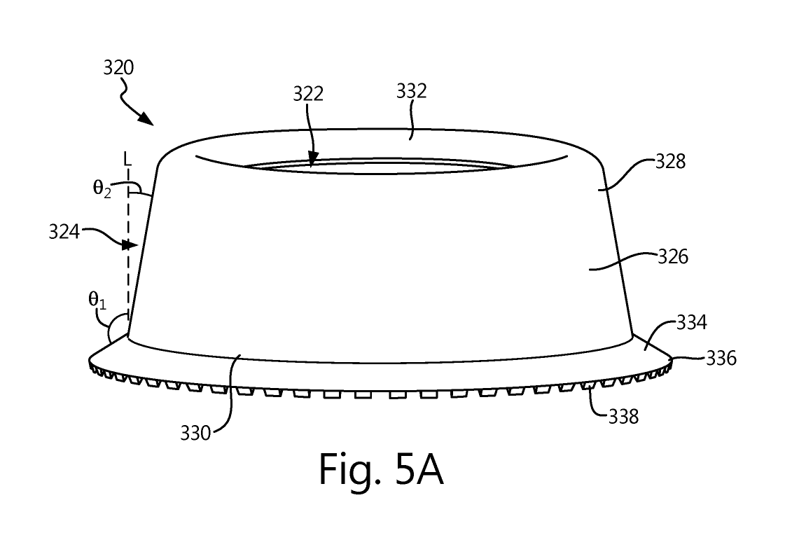

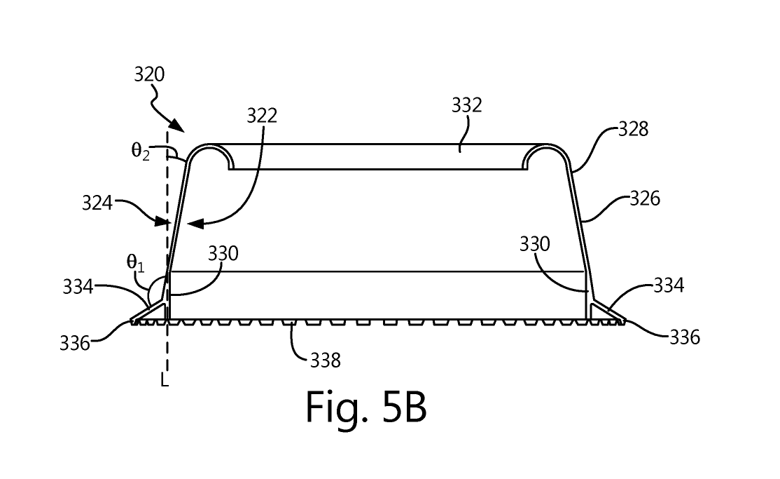

Plant edging 20 divides soil or another material adjacent to radially inner side 22 from a landscaping material adjacent to radially outer side 24. Plants, such as flowers, bushes, trees, or vegetables, are planted and grow in the soil adjacent to radially inner side 22, with plant edging 20 providing protection to the plants and ensuring the soil remains separate from the landscaping material. Plant edging 20 can be one continuous and monolithic piece that is molded or otherwise formed concurrently, or plant edging 20 can be a number of pieces fastened together through various means. Plant edging 20 can be constructed from a variety of materials, including metal, plastic, a composite material, a polymer, or another material. Plant edging 20 can be constructed from a flexible and resilient material that is able to bend and be rolled into a bale for storage and/or transportation or able to bend and curve during installation/placement to meet landscaping needs. Further, plant edging 20 can be curved to form a continuous ring (referred to as a planter ring) as shown in FIGS. 1A-1E and 5A-5B. Plant edging 20 can have various heights depending on the depth of the landscaping material and other considerations, including a height that is approximately 12.45 centimeters (4.9 inches). Similarly, plant edging 20 can have any thickness depending on the strength/rigidity needed, the type of material plant edging 20 is constructed from, the type of material on radially inner side 22, and the type of material used for the landscaping material. The height of plant edging 20 can vary along the length of plant edging 20, and the thickness of plant edging 20 can vary along the height of plant edging 20, including a greater thickness at bottom end 30 than a thickness at top end 28.

If a ring such that plant edging is a planter ring (as in FIGS. 1A-1E), plant edging 20 can be configured to be a continuous and unending ring that surrounds and protects a plant or a number of plants, delineates the soil on radially inner side 22 from grass or other materials on radially outer side 24, and provides a surface that a fabric used in landscaping can rest upon to form a seal between rib 34 and the fabric so that the landscaping material cannot seep into an area within plant edging 20. Plant edging 20 can be any size, including a configuration that has a diameter measured between opposite radially inner sides 22 of sidewall 26 that is approximately 20.32 centimeters (8.0 inches) or 45.72 centimeters (18.0 inches). Further, while plant edging 20 is shown in FIGS. 1A-1E as a circular ring, plant edging 20 can have other shapes, such as a triangle, oval, rectangle, pentagon, hexagon, or others. The circular configuration of plant edging 20 may be advantageous when used with one plant or a small number of plants, as individual plants can be surrounded by plant edging 20 without the need for the installer/landscaper to curve or bend plant edging 20 into place surrounding the plant or plants.

Sidewall 26 (also referred to as a wall) is the main structural component of plant edging 20 and extends from top end 28 to bottom end 30. Sidewall 26 provides a barrier to separate soil (and plants) on radially inner side 22 from the landscaping material on radially outer side 24. While sidewall 26 is shown in FIGS. 1A-1E as a straight extension between top end 28 and bottom end 30, sidewall 26 can be slanted/angled, wavy, zig-zagged, or another configuration. Further, sidewall 26 can extend horizontally (i.e., in a circumferential direction in FIGS. 1A-1E) in a slanted/angled, wavy, curved, zig-zagged, or another configuration. Sidewall 26 can have flanges or other members that connect to sidewall 26 (such as an inward extending flange at bottom end 30) for increased strength or for other reasons.

Head 32 is connected to top end 28 of sidewall 26. Head 32 can have a variety of configurations, including a solid circular cross-sectional member, a semi-circular cross-sectional member, a shepherds-hook shaped cross-sectional member, a rectangular cross-sectional member, a triangular cross-sectional member, or another configuration. Further, other embodiments of plant edging 20 can include a configuration that does not include a head. Head 32 can extend from radially inner side 22 (as shown in FIGS. 5A and 5B) or from radially outer side 24 (as shown in FIGS. 1A-1E). In FIGS. 1A-1E, head 32 is a shepherds-hook shaped cross-sectional member that extends from radially outer side 24 of top end 28 of sidewall 26 and has a curved cross section in which an end of head 32 curves to a point between a semicircle and a full circle. Further, head 32 includes a flange that extends inward towards radially outer side 24 of sidewall 26 and also extends downwards towards rib 34. Head 32 can have a hollow interior (within the shepherds-hook shaped cross-sectional member) or can be filled such that no void is present within head 32. Head 32 provides strength and rigidity to plant edging 20, and can be configured to be an aesthetically pleasing top to plant edging 20. Because plant edging 20 is mostly buried by soil and the landscaping material, head 32 may be the only component of plant edging 20 that is in view after plant edging 20 has been installed. Thus, it may be desirable for head 32 to be aesthetically pleasing, such as a color, coating, or material that is different than the other components of plant edging 20. Further, as may be desired, the shape and configuration of head 32 can vary along the horizontal length of plant edging 20 (i.e., in the circumferential direction).

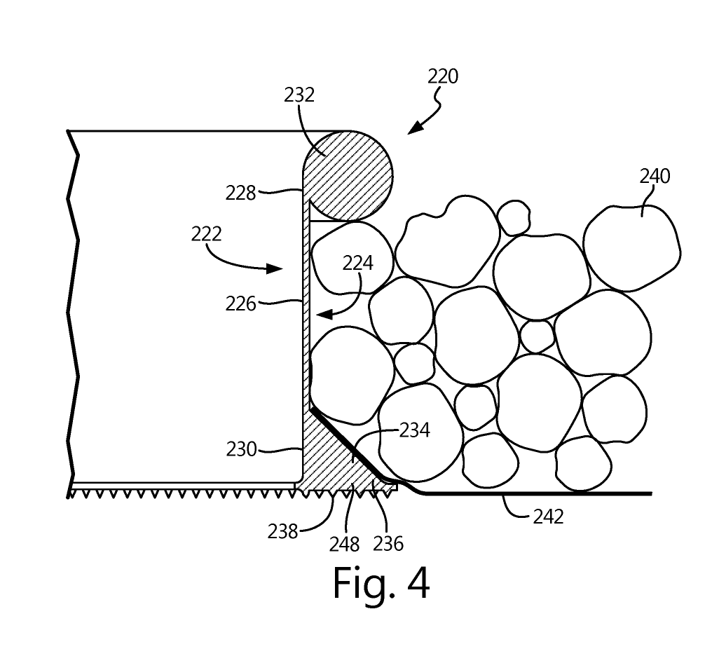

Rib 34 (also referred to as a branch) is connected to and extends from radially outer side 24 near bottom end 30 of sidewall 26. Rib 34 and bottom end 30 of sidewall 26 form a substantially V-shape with distal end 36 of rib 34 located at a point on rib 34 that is furthest from sidewall 26. Rib 34 can extend away from sidewall 26 at any angle, including an angle that is between zero and ninety degrees. In the embodiment in FIGS. 1A-1E, rib 34 extends away from sidewall 26 at a forty-five degree angle. Rib 34 can extend straight from sidewall 26 as shown in FIGS. 1A-1E, or can have another configuration, such as waves, curves, or zig-zags. The configuration of rib 34 can vary along the horizontal length of plant edging 20 (i.e., in the circumferential direction). Rib 34 can have a same or a different thickness than the thickness of sidewall 26, and rib 34 can have a varying thickness as rib 34 extends to distal end 36. Rib 34 can have flanges or other members that connect to rib 34 for increased strength or for other reasons, such as radially outward extending rib flange 39 at distal end 36. As shown in FIGS. 1A-1E, rib flange 39 is present on rib 34 that extends from distal end 36 radially outwards towards the landscaping material. Rib flange 39 can provide a surface for teeth 38, which will be described below. Bottom end 30 and distal end 36 of rib 34 can be connected to form a triangular lift lip, which can be a hollow member or a filled member that does not include a void. Such a configuration will be described in greater detail with regards to FIG. 4. With rib 34 being a lift lip, a bottom surface of rib 34 (i.e., the lift lip) can provide a greater area for teeth 38. Further, the triangular lift lip may provide added strength and rigidity to rib 34 and bottom end 30.

Distal end 36 of rib 34 can extend in a downward direction to a point that is on a plane formed by the bottom end 30 of sidewall 26 perpendicular to sidewall 26 (i.e., a plane formed by a bottom of the planter ring). Alternatively, distal end 36 of rib 34 can extend so that distal end 36 is at a point that is further downward from the plane formed by the bottom end 30 of sidewall 26 or is upward from the plane formed by the bottom end 30 of sidewall 26 (i.e., distal end 36 does not extend to the plane).

Teeth 38 are downwardly extending projections on a bottom side of bottom end 30 of sidewall 26 and on a bottom side of distal end 36 of rib 34. Teeth 38 are able to engage soil or a material on which plant edging 20 is located by digging into the material. Teeth 38 can be as long or short as needed depending on the material plant edging 20 is constructed from and on the material on which plant edging 20 is located. Each tooth of teeth 38 can be triangular, semi-circular, rectangular, trapezoidal, or other shape and can extend a distance that is constant among teeth 38 or different from adjacent teeth 38. While teeth 38 are shown in FIGS. 1A-1E as being present on both bottom end 30 of sidewall 26 and distal end 36 of rib 34, teeth 38 can be present on only one, or plant edging 20 can be configured such that teeth 38 are not present. Teeth 38 in FIGS. 1A-1E are conical projections in a downward direction configured to engage soil or another material to better hold plant edging 20 in place. Teeth 38 span the entire circumferential length of bottom end 30 and rib 34 around plant edging 20, but teeth 38 can have other configurations, such as only partially spanning the circumferential length of plant edging 20, being a constant or varied space from adjacent teeth 38, or being present only on one of bottom end 30 and rib 34.

Distal end 36 of rib 34 includes rib flange 39, which is a radially outward extending ledge. Rib flange 39 increases a bottom surface area of distal end 36 to provide a larger area to accommodate teeth 38. Further, rib flange 39 increases a surface area of rib 34 to provide a greater surface on which landscaping material can be installed/filled, making removal of plant edging 20 more difficult after landscaping material is in place. Thus, rib flange 39 aids in preventing plant edging 20 from shifting or being pulled out of the ground because rib flange 39 allows more landscaping material to be filled in on top of rib 34, increasing the weight and downward force the landscaping material exerts on rib 34 and plant edging 20.

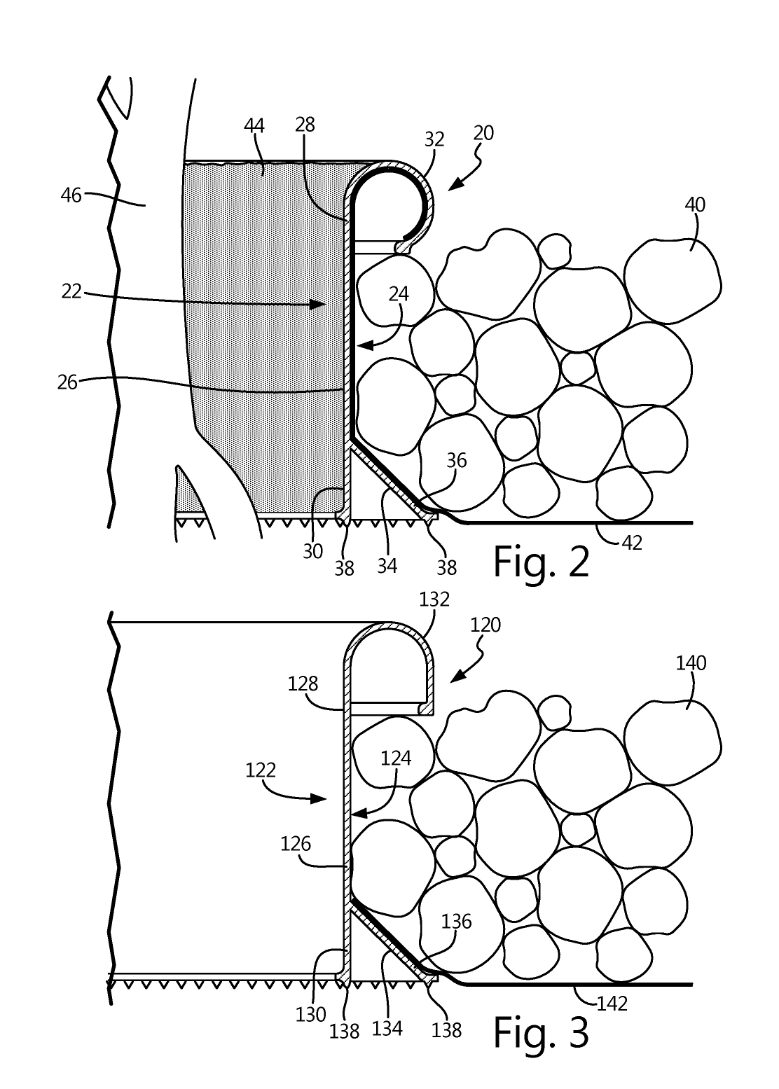

Rib 34 is configured to engage a fabric liner and provide a surface for creating a seal between rib 34 and the fabric to prevent soil or landscaping material from seeping into an area below the fabric and an area on radially inner side 22 of plant edging 20. Because rib 34 is angled/slanted, the fabric rests on rib 34 without folding over as the fabric is inclined to do if rib 34 was not present (as will be described with regards to FIGS. 2, 3, and 4). Without rib 34, the fabric is adjacent to bottom end 30 and must make a ninety-degree turn to extend up radially outer side 24 of sidewall 26. With rib 34 present, fabric 42 must only make a forty-five degree turn up rib 34 (or another angle in other embodiments of plant edging 20), providing a more suitable surface for the fabric to prevent the fabric from folding over onto itself and thus allowing a gap for the landscaping material to seep through the interface between plant edging 20 and the landscaping material. Further, after the landscaping material is filled in adjacent to radially outer side 24 so that the landscaping material is above rib 34, plant edging 20 cannot be easily and unintentionally removed because rib 34 is below the landscaping material and held in place by the weight of the landscaping material.

FIG. 2 is a cross-sectional elevation view of plant edging 20 in FIG. 1A installed in a landscaping environment. Plant edging 20 includes radially inner side 22, radially outer side 24, sidewall 26 with top end 28 and bottom end 30, head 32, rib 34, and teeth 38. Rib 34 includes distal end 36 and rib flange 39. Also shown in FIG. 2 but not part of plant edging 20 are landscaping material 40, fabric 42, soil 44, and plant 46.

Plant edging 20 in FIG. 2 is shown with landscaping material 40 adjacent to radially outer side 24 and soil 44 adjacent to radially inner side 22. Planted within soil 44 is plant 46, which can be any type of plant, including flowers, bushes, trees, vegetables, or other plants. While the material on radially inner side 22 is designated as soil 44, soil 44 can be other materials. Further, landscaping material 40 can be any type of material, including soil, rock, wood chips, gravel, sand, grass, or other materials. Plant edging 20 can be configured to fit any type and size of plants. Fabric 42 is placed between a surface of the ground and landscaping material 42 to prevent landscaping material 42 from mixing with the material that plant edging 20 and landscaping material 42 is installed upon. As stated above, plant edging 20 is configured to engage fabric 42 and provide a surface for creating a seal between plant edging 20 and fabric 42 to prevent soil 44 or landscaping material 40 from seeping into an area below fabric 42 and an area on radially inner side 22 of plant edging 20. In some embodiments, fabric 42 can be placed on rib 34 (as shown in FIGS. 3 and 4). In FIG. 2, fabric 42 is configured to extend over a top of rib 34, up radially outer side 24 of sidewall 26, and wrap around a void within head 32. Because fabric 42 is wrapped within the void within head 32, fabric 42 is held in place without folding over onto itself and thus provides a seal between fabric 42 and plant edging 20. The configuration of fabric 42 extending into the void within head 32 can be utilized with other embodiments, and plant edging 20 can include other components to hold fabric 42.

FIG. 3 is a cross-sectional elevation view of one embodiment of a plant edging. Similar to plant edging 20, plant edging 120 includes inner side 122, outer side 124, sidewall 126 with top end 128 and bottom end 130, head 132, rib 134 with distal end 136, and teeth 138. Also shown in FIG. 3 but not part of plant edging 120 are landscaping material 140 and fabric 142.

Plant edging 120 is similar in configuration and functionality to plant edging 20, except that head 132 of plant edging 120 is a semi-circular cross-sectional member, and plant edging 120 does not have an annular shape. Also, fabric 142 extends only to a point where rib 134 connects to sidewall 126.

In FIG. 3, head 132 extends from outer side 124 of top end 128 of sidewall 126 and has a semi-circular cross-sectional member with a flat, partially inwardly extending and partially downwardly extending flange. Head 132 extends out from outer side 124 of top end 128 of sidewall 126. Head 132 can have a hollow interior (within the semi-circular cross section) or can be filled such that no void is present within head 32. The configuration of head 132 in FIG. 3 can provide additional strength and rigidity to plant edging 120, and can be an aesthetically pleasing top to plant edging 120 because plant edging 120, when installed, is mostly buried by soil and landscaping material 142. As may be desired, the shape and configuration of head 132 can vary along a horizontal length of plant edging 120 (i.e., into the page in FIG. 3).

FIG. 4 is a cross-sectional elevation view of another embodiment of a plant edging. Similar to plant edging 20 in FIGS. 1A-1E and 2 and plant edging 120 in FIG. 3, plant edging 220 includes inner side 222, outer side 224, sidewall 226 with top end 228 and bottom end 230, head 232, rib 234 with distal end 236, teeth 238, and lift lip 248. Also shown in FIG. 4 but not part of plant edging 220 are landscaping material 240 and fabric 242.

Plant edging 220 is similar in configuration and functionality to plant edging 20 in and plant edging 120, except that head 232 of plant edging 220 has a filled in, circular cross section, and plant edging 220 includes lip lift 248, which forms a filled in triangular member in conjunction with bottom end 230 and rib 234.

Head 232 has a cross section that is circular in shape and extends from outer side 224 of top end 228 of sidewall 226. Head 232 is filled in such that no void is present within head 232, but other configurations can include a head that has a hollow interior. The configuration of head 232 in FIG. 3 can provide additional strength and rigidity to plant edging 220, and can be an aesthetically pleasing top to plant edging 220 because plant edging 220, when installed, is mostly buried by soil and landscaping material 240. While head 232 is shown as having a circular cross section, head 232 can have other shapes and configurations, such as an oval shape, a square or rectangular shape, a triangular shape, or another shape. Also, head 232 can extend directly upward from top end 228 of sidewall 226 such that a portion of head 232 is on inner side 222 and a portion of head 232 is on outer side 224. As may be desired, the shape and configuration of head 132 can vary along a horizontal length of plant edging 220 (i.e., into the page in FIG. 4).

Lift lip 248 connects bottom end 230 of sidewall 226 and rib 234 to form a triangular-shaped member connected to outer side 224 of bottom end 230 of sidewall 226. Lift lip 248 can be filled such that no void is present within lift lip 248, as shown in FIG. 4, or can have a hollow interior. The configuration of lift lip 248 can provide additional strength and rigidity to plant edging 220, including bottom end 230 and rib 234. Further, the configuration of plant edging 220 including lift lip 248 provides a greater downward-facing surface area to which teeth 238 can be connected to and extend from to engage the soil or another material. Bottom end 230, rib 234, and lift lip 248 can have other shapes and configurations, including a stair-stepping configuration, a curved configuration, or another shape. The shape and configuration of bottom end 230, rib 234, and lift lip 248 can vary along a horizontal length of plant edging 220 (i.e., into the page in FIG. 4).

FIG. 5A is a perspective view of another embodiment of a plant edging, and FIG. 5B is a cross-sectional elevation view of the plant edging of FIG. 5A. Plant edging 320 includes radially inner side 322, radially outer side 324, sidewall 326, head 332, rib 334 with distal end 336, and teeth 338. Sidewall includes top end 328, bottom end 330, and hoop 331 at bottom end 330. Angle θ₁ is an angle between vertical line L and rib 334, while angle θ₂ is an angle between vertical line L and radially outer side 324 of sidewall 326. The configuration and functionality of plant edging 320 is similar to that of plant edging 20 of FIGS. 1A-1E and 2, plant edging 120 of FIG. 3, and plant edging 220 of FIG. 4. Like plant edging 20, plant edging 320 is configured to be a continuous and unending ring that surrounds and protects a plant or a number of plants, delineates the soil on radially inner side 322 from the landscaping materials on radially outer side 324, and provides a surface that a fabric used in landscaping can rest upon to form a seal between rib 334 and the fabric so that landscaping material cannot seep into an area within plant edging 320.

Plant edging 320 can be constructed from the same materials as plant edging 20. Plant edging 320 can be one continuous and monolithic piece that is molded or otherwise formed concurrently, or plant edging 320 can be a number of pieces fastened together through various means. Similar to plant edging 20, plant edging 320 can be any size, including a configuration that has a diameter measured between opposite sides of a radially innermost point of head 332 that is approximately 20.32 centimeters (8.0 inches) or 45.72 centimeters (18.0 inches). Further, while plant edging 320 is shown in FIGS. 5A and 5B as a circular ring, plant edging 320 can have other shapes, such as a triangle, oval, rectangle, pentagon, hexagon, or others. Plant edging 320 can have a variety of heights depending on a depth of the landscaping material, a size and type of plant within plant edging 320, the type of material used within plant edging 320, and other considerations. For example, plant edging 320 can have a height that is approximately 12.45 centimeters (4.9 inches). Plant edging 320 can have any thickness depending on the strength/rigidity needed, the type of material plant edging 320 is constructed from, and the type and density of soil and the landscaping material. The height of plant edging 320 can vary along a circumferential length of plant edging 320, and a thickness of plant edging 320 can vary along the height and/or circumferential length of plant edging 320, including a greater thickness at bottom end 330 than a thickness at top end 328.

Sidewall 326 is angled/slanted inward such that top end 328 is radially inward from bottom end 330. Sidewall 326 is angled from vertical line L at angle θ₂. Sidewall 326 can be slanted at any angle θ₂ when measured from vertical line L (i.e., perpendicular to a plane formed by a bottom of plant edging 320). In plant edging 320, sidewall 326 is slanted at angle θ₂ that is an approximately ten degree angle, but angle θ₂ can be more or less depending on design considerations and preferences. On bottom end 330 of sidewall 326 is hoop 331, which is an unslanted, downwardly extending cylinder. Hoop 331 and the slanted portion of sidewall 326 connect to one another near a point where rib 334 and sidewall 326 connect. Hoop 331 can provide more strength and rigidity in plant edging 320 in the area near bottom end 330. While the embodiment of plant edging 320 in FIGS. 5A and 5B is shown to have hoop 331, other embodiments with a slanted sidewall 326 do not need to include hoop 331.

Rib 334 extends from radially outer side 324 at a point near where sidewall 326 and hoop 331 connect. Rib 334 is similar to rib 34 of FIGS. 1A-1E and 2. However, as shown in FIGS. 5A and 5B, rib 334 extends from radially outer side 324 at angle θ₁ that is approximately sixty degrees when measured from vertical line L (i.e., perpendicular to a plane formed by a bottom of plant edging 320). While θ₁ is shown as a sixty degree angle, angle θ₁ can be more or less depending on design considerations and preferences. With angle θ₁ being sixty degrees, rib 334 extends further radially outward than if angle θ₁ was smaller because distal end 336 of rib 334 extends to a point that is on a plane formed by a bottom of plant edging 320 and, particularly, formed by a bottom side of hoop 331.

Head 332 has the same functionality as head 32 in FIGS. 1A-1E and 2, but head 332 extends radially inward from radially inner side 322 of top end 328. Head 332 can have a variety of configurations, including a solid circular cross-sectional member, a semi-circular cross-sectional member, a shepherds-hook shaped cross-sectional member, a rectangular cross-sectional member, a triangular cross-sectional member, or another configuration. Further, other embodiments of plant edging 320 can include a configuration in which head 332 extends radially outward from radially outer side 324 of top end 328 or a configuration that does not include a head. In FIGS. 5A and 5B, head 332 is a semi-circular cross-sectional member. Head 332 can have a hollow interior (within the semi-circular section) or can be filled such that no void is present within head 332. Head 332 provides strength and rigidity to plant edging 320, and can be configured to be an aesthetically pleasing top to plant edging 320. Because plant edging 320 is mostly buried by soil and landscaping material, head 332 may be the only component of plant edging 320 that is in view after plant edging 320 has been installed. Thus, it may be desirable for head 332 to be aesthetically pleasing, such as a color, coating, or material that is different than the other components of plant edging 320. Further, as may be desired, the shape and configuration of head 332 can vary along a circumferential length of plant edging 320.

Teeth 338 are downwardly extending projections on a bottom side of hoop 331 and on a bottom side of distal end 336 of rib 334. Teeth 338 are able to engage soil or a material on which plant edging 320 is located by digging into the material. Teeth 338 can have any configuration as needed, such as a trapezoidal shape as shown in FIGS. 5A and 5B. Teeth 338 can be present on neither, one, or both of hoop 331 and distal end 336 of rib 334.

With plant edging 320 having an angled/slanted sidewall 326 such that a top of the planter ring has a diameter that is smaller than a diameter of a bottom of the planter ring, multiple annular plant edgings 320 can be stacked on one another during storage and transportation to increase efficiency and save space.

Plant edging 20/120/220/320, which can also be configured in a ring to form a planter ring, is disclosed herein having sidewall 26/126/226/326, head 32/132/232/332 at top end 28/128/228/328 of sidewall 26/126/226/326, and rib 34/134/234/334 connected to and extending away from outer side 22/122/222/322 of plant edging 20/120/220/320. Plant edging 20/120/220/320 provides protection to plants on inner side 24/124/224/324 and delineation from grass or other landscaping materials on outer side 22/122/222/322. Rib 34/134/234/334, also called a branch, can form a substantially V-shape with bottom end 30/130/230/330 of sidewall 26/126/226/326. Rib 34/134/234/334 is configured to engage soil or landscaping material 42/142/242, such as stone/gravel, wood chips, or sand, to prevent plant edging 20/120/220/320 from shifting or being pulled out of the ground. Rib 34/134/234/334 is also configured to engage fabric 42/142/242, which is a liner that is commonly utilized in landscaping, with rib 34/134/234/334 by providing an angled surface to create a seal between plant edging 20/120/220/320 and fabric 42/142/242 that prevents soil or landscaping material 40/140/240 from seeping through an interface between the two. Rib 34/134/234/334 can extend at any angle and can be any length, including an angle that is as much as or more than sixty degrees from sidewall 26/126/226/326 and a length in which distal end 36/136/236/336 of rib 34/134/234/334 extends further downward than bottom end 30/130/230/330 of sidewall 26/126/226/326. Further, rib 34/134/234/334 and bottom end 30/130/230/330 of sidewall 26/126/226/326 (the V-shape) can form lift lip 248 that connects distal end 36/136/236/336 of rib 34/134/234/334 and bottom end 30/130/230/330 to form a triangular member at the bottom of pant edging 20/120/220/320 for more support and strength. Teeth 38/138/238/338 can be located on bottom end 30/130/230/330 of sidewall 26/126/226/326 and on distal end 36/136/236/336 of rib 34/134/234/334 to aid in engagement of plant edging 20/120/220/320 with the soil or landscaping material 40/140/240.

Any relative terms or terms of degree used herein, such as “substantially,” “essentially,” “generally,” “approximately,” and the like should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations; incidental alignment variations; alignment or shape variations induced by thermal, rotational, or vibrational operational conditions; and the like. While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A plant edging having an inner side and an outer side comprising:
a sidewall having a top end and a bottom end with the bottom end configured to engage soil;
a head connected to the top end of the sidewall; and
a rib connected to and extending away from the outer side near the bottom end of the sidewall to form a substantially V-shape with the bottom end of the sidewall, the rib having a distal end configured to engage soil.

2. The plant edging of claim 1, wherein the sidewall, head, and rib form a ring that is continuous and configured to contain a plant within the ring, the inner side of the plant edging being radially inward from the outer side of the plant edging.

3. The plant edging of claim 2, wherein the sidewall is angled such that the top end of the sidewall and the head are radially inward from the bottom end of the sidewall and the rib.

4. The plant edging of claim 3, wherein the angle of the sidewall is between five degrees and fifteen degrees when measured from a line that is perpendicular to a bottom of the ring.

5. The plant edging of claim 2, wherein the distal end of the rib extends to a point on a plane formed by a bottom of the ring.

6. The plant edging of claim 1, wherein the head is a curved flange that is continuous with the top end of the sidewall and is radially inward from the top end of the sidewall.

7. The plant edging of claim 1, wherein the head is a curved flange that is continuous with the top end of the sidewall and is radially outward from the top end of the sidewall.

8. The plant edging of claim 1, wherein the head is a circular member connected to the outer side of the top end of the sidewall.

9. The plant edging of claim 1, wherein the bottom end of the sidewall and the rib form a lift lip with a triangular shape connected to the outer side of the bottom end of the sidewall, the lift lip having teeth on a downward side.

10. The plant edging of claim 1, wherein the rib extends away from the sidewall at an angle between zero degrees and sixty degrees when measured from a line parallel to the bottom end of the sidewall.

11. The plant edging of claim 1, further comprising:
teeth connected to the bottom end of the sidewall that are configured to engage soil.

12. The plant edging of claim 1, further comprising:
teeth connected to the distal end of the rib that are configured to engage soil.

13. A planter ring comprising:
a wall that is annular in shape and has a radially inner side, a radially outer side, a top end, and a bottom end; and
a branch that is annular in shape and connected to the radially outer side of the wall near the bottom end, the branch extending to a point on a plane formed by a bottom of the planter ring.

14. The planter ring of claim 13, further comprising:
a head that is annular in shape and connected to the top end of the wall.

15. The planter ring of claim 14, wherein the head extends from a radially inner side of the wall.

16. The planter ring of claim 14, wherein the head extends from a radially outer side of the wall.

17. The planter ring of claim 13, wherein the wall is a substantially frustoconical shape.

18. The planter ring of claim 13, wherein the branch extends away from the radially outer side of the wall at an angle between zero and sixty degrees when measured from a line parallel to the bottom end of the wall.

19. The planter ring of claim 13, wherein the bottom end of the wall and the branch form a lift lip having a triangular shape.

20. The planter ring of claim 13, further comprising:
teeth on a bottom side of the branch configured to engage soil.
